(19) United States
(12) Patent Application Publication
(10) Pub. No.: US 2005/0021363 A1
(43) Pub. Date: Jan. 27, 2005

(54) Debit card per-transaction charitable contribution

(76) Inventors: Gregory F. Stimson, Westlake Village, CA (US); Robert B. Kay, Westlake Village, CA (US)

Correspondence Address: Michael J. Ram;KOPPEL, JACOBS, PATRICK & HEYBL, Suite 107, 555 St. Charles Drive, Thousand Oaks, CA, 91360, US

(21) Appl. No.: 10/897,878

(22) Filed: Jul. 22, 2004

Related U.S. Application Data
(60) Provisional application No. 60/490,232, filed on Jul. 25, 2003.

(51) Int. Cl. G06F 17/60; G06K 5/00

(52) U.S. Cl. 705/1; 705/41

(57) ABSTRACT

A procedure and method which use a debit, stored value, or prepaid stored value card, or a similar card or account that has a value but does not extend credit to the card holder, to provide a designated funding amount to a selected non-profit or charitable organization or entity identified by the card where the funding amount is transferred with each transaction, such as a purchase, deposit (load) or cash withdrawal, using that card.

Benefit is claimed of Provisional Patent Application Ser. No. 60/490,232 filed Jul. 25, 2003.

This application relates to a procedure and method by which a debit, stored value, or prepaid stored value card, or a similar card or account that has a value but does not extend credit to the card holder (accountholder), provides a designated funding amount to a selected non-profit or charitable organization or entity identified by the card where the funding amount is transferred with each transaction, such as a purchase, deposit (load) or cash withdrawal, using that card.

### BACKGROUND

Many different business transaction schemes have been suggested to facilitate the reservation or isolation of a certain portion of the funds paid for the purchase of an item or service, or to add a specific amount or percentage of the purchase price (referred to as an excess) to the price of a purchase. That excess is then allocated to a separate entity, entities or activity.

An example of a common and well known procedure is to increase the purchase price of an item at the cash register by a fixed percentage, namely a sales tax, the purchaser then being charged the purchase price plus sales tax (excess), referred to as the transaction amount. The transaction amount may then be paid by cash, check or a wide variety of money charging cards, such as credit cards, debit cards, smart cards or cards having a prepaid stored value, such as a gift cards or certificates. The merchandise seller, or an entity working with the seller, then sends the excess portion to the necessary governmental agency or agencies responsibly for collection of the tax, i.e., federal, state, county, city, etc. tax collection agencies.

There are also examples of establishments which pledge to isolate a fixed excess or portion from each purchase price and send that portion of each purchase price to a third party such as a charity. Further examples are credit cards purveyors or banks which give a fixed percentage of each purchase charged on their card back to the purchaser in the form of a rebate, or purchase savings bonds. The consumer can use that excess, or deposit the excess in a retirement or similar fund elected by the card owner or send the excess, or designate payment of that excess or a portion thereof, to an organization or entity, such as an organization affiliated with the card. Also, it is common for frequent flier or frequent user credit to be generated as a result of purchases, these credits usable for future purchases or gifts.

U.S. Pat. No. 5,466,919 to Hovakimian is an example of the use of a credit/charge card for purchasing goods where the cards in the system identify a charity or charities to receive a donation when a purchase is made. The purchase processing system processes the card user's transaction, pays a previously decided amount to the charity or charities and also bills the cardholder. In this system, the donated amounts may be paid by the bank or card issuing organization or the cardholder may add an amount which he pays to the selected charity. The card user is subsequently billed by the card processor for the designated charity amount.

Burke has several patents to an automatic philanthropic contribution system directed primarily to cash transactions and cash register or point of sale terminals and software to process those transactions. They do not use a credit or debit card as the means for transferring funds to a charity. Instead, as set forth in U.S. Pat. No. 5,621,640, a separate donor card is used, with the purchaser entering a donor card number into the cash register at the time of purchase, allowing the donor to set aside and contribute an amount to a designated charity at the time of purchase. U.S. Pat. No. 6,088,682 describes establishing, maintaining, and accumulating credits in a payor's account. Merchants forward data and funds received at the time of a cash purchase to a clearinghouse for apportionment and distribution for services or goods. While the examples in the patent refer to cash, the Burke system is also applicable to payment by credit card. If paying by credit card, the customer designates, at the time of purchase, a donation amount to be charged to the credit card in excess of the price of the goods or service purchased. U.S. Pat. No. 6,112,191 describes a “rounder” system which creates excess funds from payments and without the cooperation or even awareness of the payee. The system creates excess funds by applying a determinant to the face amount or number of account entries, e.g. checks, ATM withdrawals, credit and debit drafts. In the rounder system, the excess funds allocation occurs at the “back end” of the commercial cycle when check and credit drafts are debited against their existing account balances. A pre-designated amount of funds are added or subtracted, as directed, to the face amount of each transaction and then the users account balance is adjusted accordingly. The amount of excess funds are then displayed in the account and periodically transferred to accounts for provider services, i.e., mutual funds, annuities, merchandise, charities, etc. The excess funds that are created by the rounder system are held internally by the bank or credit institution or assigned to other designated providers. When a consumer uses the rounder system to create excess funds from spending transactions, they set aside funds for a designated purpose, every time they spend, regardless of whether they use cash, write a check, use an ATM machine or use a credit or debit card.

U.S. Pat. No. 6,164,533 to Barton is directed to a point of sale forced savings program for automatically moving monies from a debit account to a savings account upon making a purchase with a debit, credit or calling card. When a user makes a purchase the card processor/bank automatically adds a user pre-designated percentage to the purchase, or rounds up the purchase amount to the nearest dollar, or does both (add a fixed percentage and then round up) to determine an additional amount (the excess) to be removed from the users account or to be billed on the users credit card statement. That excess is then placed in the user's designated savings account. A similar forced savings plan is set forth in U.S. Pat. No. 6,631,358 to Ogilvie, in which a user enters into an agreement with the card provider which directs a specified incremental amount of purchases or transactions be directed to a separate savings vehicle. The Ogilvie patent contemplates use of a credit card, charge card, debit card, smart card, ATM or bank card, prepaid card, or online, electronic money or other electronic funds transfers, and/or similar transactions.

U.S. Pat. No. 6,581,041 to Canney links charitable contributions to an investment or consumer purchase. In the first instance the service provider, namely the broker in the investment situation redirects a portion of the transaction processing fee to a charitable foundation. In the second instance the credit/debit card company in a purchase transaction redirects a portion of the percentage of the transaction withheld from the merchant as handling fee to a charitable foundation. Under these scenarios the contribution is being made by the broker, credit/debit card company, or merchant, to a charity chosen by the merchant rather than the purchaser, as the merchant is giving up a portion of their normal processing/transaction fees. The purchaser/consumer sees no additional charge added to the purchase price and therefore the charitable contribution is not made by the purchaser.

These prior systems have several deficiencies including, but not limited to, their method of use, ease of performing the transaction, isolating and transferring funds to designated charities and accounting procedures which allow the purchaser to maintain records and obtain tax deductions for the contributions made. These deficiencies are addressed by the per-transaction funds transfer system utilizing features of the invention set forth herein.

### SUMMARY

As part of the normal use of a debit card, or other pre-funded (stored value, prepaid, gift card) money transfer system, a transaction or use fee is charged to the user for each transaction and that fee is automatically deducted from the funds deposited by the card user (accountholder). In accordance with the procedures herein described, for each card transaction a portion of that use fee or a separate per transaction “contribution” fee is automatically transferred to the designated entity or non-profit organization. If the designated entity or organization qualifies under IRS rules as a charity, each debit card transaction generates a tax deductible contribution for the card user. To assist individuals in making charitable contributions an everyday event rather then an occasional, unscheduled activity, applicant has developed a program that makes giving, and recording the amount given, an easy and routine matter. Every time a pre-funded card utilizing the system is used to make a purchase at a merchant, cash is withdrawn from an ATM, or any other designated card activity is performed, a small nominal transaction fee is assessed. Because of the ease to operate the system and the minimization of operating and overhead costs, a substantial portion of the retained fees are distributed directly to the charitable organization on behalf of the cardholder. Depending on the organization's and cardholder's tax status, these fees may be tax deductible to the cardholder.

### BRIEF DESCRIPTION OF DRAWINGS

FIG. 1 is a schematic diagram showing flow of information and funds using a debit card incorporating features of the invention.

### DETAILED DESCRIPTION

Raising funds that allow a charitable or non-profit organization to operate comfortably is a continual challenge. This is especially true for educational and non-profit organizations that are dependant on Federal, State, and Local budgets required to fund the programs that it provides. The quality of these programs can be affected tremendously as a result of changes in the economic climate, demographics, legislation, or existing sponsorships. Individuals are constantly approached to provide financial support to many worthy causes. Because individuals have not established a habit of continuously providing aid to these organizations, it is necessary that the non-profit organizations must continuously conduct find raising events and solicit contributions. According to the Association of Fund-Raising Distributors and Suppliers (AFRDS), over $2 billion was raised in 2002 by non-profit organizations selling product with the average fundraiser generating over $6,000 in retail sales. This is a time consuming and costly method of raising funds.

The system described herein, referred to as a debit card system but generally encompassing all pre-funded purchasing vehicles, provides an automatic contribution and transfer of funds to designated organizations, serving to supplement fund raising efforts by providing a long-term recurring revenue stream, thus easing the financial dilemma, assisting the organization in raising funds, and providing the community with a service they can use and appreciate. Further, this can be accomplished without the use of large numbers of individuals, the stress of handling product, such as in charity based sales of goods, and directly competing with initiatives that are already in place. In a preferred embodiment of the system, every time an accountholder uses the account, for example a system debit card is used, whether it is used to make a purchase at a merchant, to withdraw cash from an ATM, or any other card activity is performed, a pre-designated transaction fee is assessed to the debit card (card holders) account. Under normal card usage, transaction fees to the cardholder will usually average $10 to $15 per month; however, the amount can be set by the user to be higher or lower or be restricted to certain types of transactions. After the program administration fees are withdrawn from the transaction fee, the designated per-transaction amount for the charity is distributed directly to the designated organization. Alternatively, the designated donation amount may be accrued and transferred at designated intervals (weekly, monthly, quarterly, etc). Because these fees are deducted from the card users funds, depending on the IRS tax status of the recipient, they may provide a tax deduction for the cardholder. Additional benefits can be derived when the system debit cards are used in conjunction with other programs which compliment the per-purchase contribution system.

In one embodiment the system cards are bank sponsored ATM/Debit (Stored Value) Cards. They can be private labeled or branded, such as with American Express, MasterCard, VISA or other common debit or credit card logos. Additionally, they can be personalized with the cardholder's name or be anonymous without a user name and, if desired, carry the sponsoring organization's artwork and graphics. While they are debit cards, they look like a credit cards. Also while they are not smart cards, they function similarly. Debit Cards enable the cardholder to make purchases at business establishments that accept debit cards which display the logos of the networks in which the card participates. They are not credit cards, because the purchases are limited to the current pre-funded value of the card account at the time of the purchase. The cardholder typically uses a PIN (Personal Identification Number) or a signature for security when making a purchase. The card network logos where the card may be used (i.e., Star, Cirrus, Interlink, Plus, Maestro, etc.) are typically printed on the back of the card. One particular advantage of a debit card which distinguishes it from a credit card is that a funds transfer system incorporating features of the invention does not require a checking account, extension of credit, or a credit check so almost anyone may sign up for it.

However, the system is not limited to debit cards and may be used in conjunction with any manner of pre-funded funds transfer system. These include, but are not limited to ATM cards, gift cards, funds transfer cards and electronic bill paying or funds transfer arrangements.

ATM Cards—may be used at automated teller machines to obtain cash from a funded account. With the associated network capability of the cards, there are over 1 Million ATM locations worldwide where a cardholder may withdraw cash from their account.

Funds Transfer Cards—may be used to transfer funds (available money/value) to another card. Other family members or relatives can purchase cards, which can be used in the program. Each card has its own account number and PIN so that each cardholder has individual control of their activities and funds. A typical transaction might be the routine transfer of money to family members overseas or foreign bank accounts or students at college. This reduces costs over other competing transfer methods, such as using money orders, Western Union or MoneyGram methods, as well as reduces the time involved in the purchase and transfer using these competing forms of funds transfer. Such funds transfer can also be accomplished instantly by using or accessing the card account through customer service lines or the Internet, following specific prompts to transfer the desired amounts to another cardholder's account. Presently over $41 Billion annually is sent to relatives and family outside the United States; over $10 Billion annually to Latin American countries. The Nilson Report forecasts that this will grow to 280 million transactions worth $18 Billion by 2005. The system described herein can be used to allocate a portion of those transferred funds to specified supplemental recipients (charities).

Electronic Bill Paying Systems—enables the cardholder to pay for many routine, repetitive services, for example utilities, online electronically. This eliminates the need for the payor to obtain money orders or fund other equivalents and deliver or mail them as payment to the service provider. Presently, over 975 million money orders are purchased annually.

The system may also encompass other services typically identified as a payroll card, travel/expense card, prepaid calling card, prepaid wireless purchase card, shopping card, benefit card, allowance card, gift card, loyalty card, claims payment card, online shopping card, campus card, etc. all of which typically have a predetermined value which is reduced by making purchases using the card. In a more preferred embodiment the card holder (accountholder) has a preselected access code, usually referred to as a PIN number, which is entered into the electronic system at the time the card is used or the electronic system is otherwise accessed.

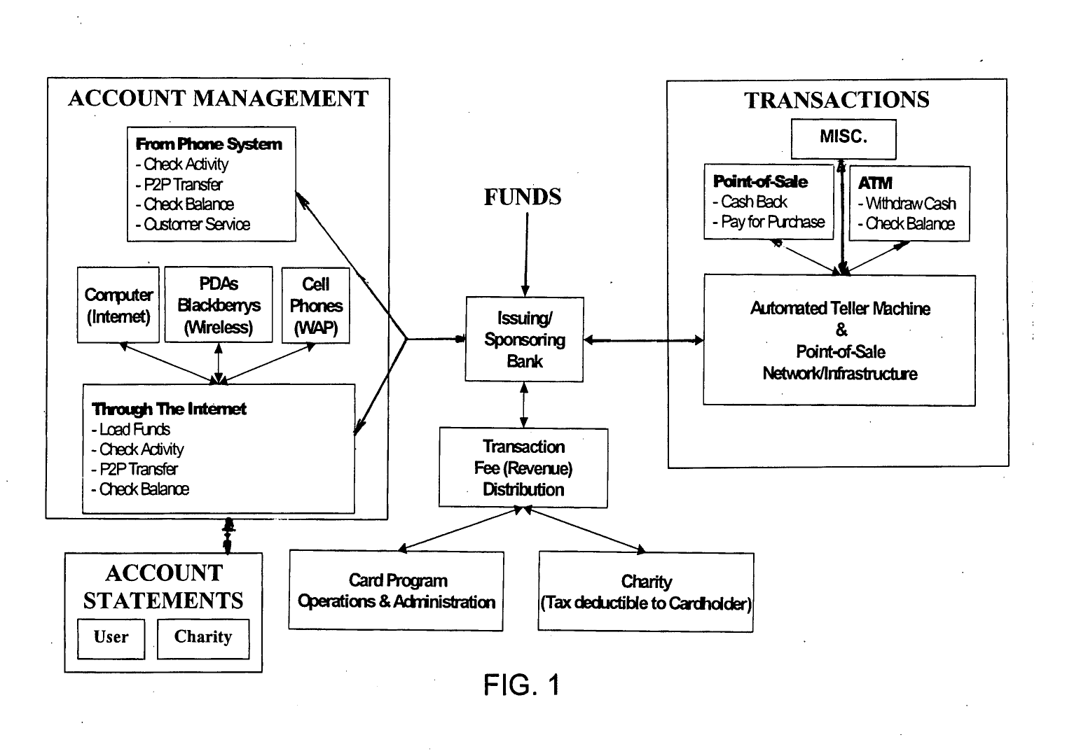

Operation of a first embodiment—FIG. 1 schematically shows various transactions and the flow of funds. Every time a system card is used to make a purchase at a business establishment, cash is withdrawn from an ATM, money is transferred between cards, funds are added to a card, bills paid on line or a transaction which results in a transfer of funds is completed, a predetermined transaction fee is assessed. The transaction fee is subtracted from the card's available balance at the time of the transaction along with the value of the purchase, withdrawal or transaction in real-time. Program operating costs are deducted and the balance of the fees (rebated on behalf of the cardholder) are distributed directly to the designated organization or their accounts. The transaction fee may be designated to vary by how the card is being used or the amount of the transaction. This is in addition to other fees which may be charged by third parties as a result of the transaction. Since all of the processing is handled in real-time, the value of the purchase/withdrawal and associated transaction fee is instantly subtracted from the cardholder's available card balance. In a preferred embodiment, funds from the transaction fees are immediately available by transfer to the account of the designated organization by the bank sponsoring the card or, alternatively, accumulated in a reserve account, for later transfer at designated time intervals or dollar amounts. Typical transaction fees to the cardholder average $10 to $15 per month with normal usage. A transaction record is generated and the card user and designated organization receive periodic (usually monthly) statements of the relevant information regarding the dollar amount of the transactions, the various fees deducted and the recipients of the fees. Because the fees distributed to the designated organization may provide a tax deduction to the cardholder, depending on the organization's tax status, an annual statement is also usually provided showing, as a minimum, the name(s) of the recipient and the total contributions derived from the transaction fees.

There are multiple ways (e.g., check, wire, credit card, debit card, automatic clearing house, money order, cash deposit, direct deposit) to reload or increase the amount of money available on the card as the funds are used, generally depending on the individual's needs and situations. While not necessary, there typically is a small, nominal transaction fee collected in real-time when these additional funds are deposited to the card. Fees vary by method and may include additional fees charged by the other service providers.

As indicated above, the system provides information to both the cardholder and the designated organization through activity reports. For cardholders, transaction information may be available as paper copies through the mail, through an automated telephone system (IVR) and/or through a secure access web site. For example, on the web site, details of card use, deposits, and various fees are displayed so that the user can easily track his or her spending habits, check on how the card is being used and assure that funds are reported as distributed to designated organizations. In a further embodiment, reports to the designated organization showing the funds transfer can also be transmitted to the card user so that he can verify that the funds withdrawn from his account were in fact distributed to the designated organization.

The system can also provide custom reports to the designated organizations summarizing where the cards are being used and the transaction fees generated at each merchant or with each type of transaction. Reviewing the merchant summary can be beneficial in helping an organization to enhance its sponsorship efforts. By knowing how much an organization's card users are spending and where they are spending, a designated charity can create programs to persuade business establishments to provide discounts to users of the card or to donate to the identified cause, in turn stimulating additional sales for the merchant.

In order to protect cardholders' privacy only summarized information without cardholder names, specific identifying information, or account numbers are provided to the designated organization. Access to nonpublic personal information about cardholders is restricted to those who need to know that information. The card issuer/bank maintains physical, electronic, and procedural safeguards that comply with federal standards, regulatory, and card association network rules and regulations to guard the private information of both the designated charity and the cardholders.

In one embodiment of the debit card programs described herein, the non-profit organization/charity enters into an agreement with a card management organization, which in turn manages operation of the system. The non-profit also signs an agreement with a designated card-sponsoring Bank and the non-profit opens an account at the sponsoring/issuing bank. The non-profit organizations account is then used for the designated fee transfer from transactions from card accounts issued to individuals enrolled in the program, with the bank collecting and distributing the transaction fees.

The card management organization coordinates card manufacturing, embossing, encoding, personalization, and fulfillment of cards to approved cardholders. Branding the card with the designated organizations artwork and graphics provides many intangible benefits such as building and improving community recognition; encouraging sponsor loyalty; and attracting new sponsors and strengthening existing relationships. Further, if the non-profit organization has a sponsor assisting in the program or covering some of the costs of the program, the name and logo of the sponsor may also appear on the card.

Costs associated with the program include, but are not limited to, the production of the cards, card marketing literature and packaging, operating the personalized web site(s), card network costs, and configuration and operations of the automated telephone system for sponsoring non-profit organizations. The sponsoring non-profit organization can give the card to users, absorbing these costs, or charge a membership/start-up fee to recover some of these costs.

### EXAMPLE 1

A school ATM/debit card program is an example of one embodiment of the card system. It is designed to help a school district raise funds and alleviate or mitigate some of current budget issues. Many public schools have found that finds available from taxes and/or state distributed funds are not adequate to pay for supplies necessary to provide adequate education (books, pens and paper, course materials, etc.), or to fund desirable programs, such as sports teams, art, music and shop programs and other extracurricular activities as well as a variety of academic classes, such as the availability of foreign language classes. Schools have therefore been required to charge students if they wish to participate, thus placing the financial burden on the students and their family, and possibly limiting those programs to only those who can afford to participate. An ATM/debit card program as described above provides additional finds for such programs and will help to keep these programs or add programs that children need and enjoy. Under the program, parents, or other individuals desiring to assist in financially supporting adequate educational programs, regardless of geographic location, would become participants in a debit card system sponsored by the school. Every time that a participating individual uses the card a small transaction fee is charged. After subtracting card system operating costs the remainder of the transaction fee, typically between 40% to 60% of the transaction fee, goes to the sponsoring school or school district and provides a tax deduction for the card user, as a charitable donation. As an added feature, the user may specify how the contribution is allocated to each school site in the district. All funds are handled and distributed instantly by a FDIC insured bank sponsoring the program. To provide further funds to the school, the debit card can be combined with other programs, such as eScript™. As a part of the program the sponsor receives a report of merchants where the card is used. The sponsor can then approach the merchant to provide further financial incentives to those users, which will generate more funds for the school and encourage users to increase use of the debit card at these frequently used merchant locations. This also helps the merchant because it encourages users to increase their patronage of those merchants who provide the added incentives to the community.

The school ATM/debit card is not a credit card—no interest becomes due, bank accounts are not necessary, no credit checks are required, and they can be issued to cardholders as young as 13 with parental consent. However, it works similar to a credit card, thus making the program particularly user friendly for individuals who are in lower or middle income brackets and typically spend each pay check and don't have established savings programs but still wish to assist in improving the education provided to their children. The user adds money to the card, i.e. funds the card, for example, deposits a pay check into the card account, or uses direct deposit of the pay check, and then uses the card anywhere that accepts ATM/Debit cards. Their money can be withdrawn at over 1 million ATM machines worldwide, the user can pay for food at the supermarket, get cash back at Point-of-Sale locations with a purchases and transfer funds easily to other individuals within the card system.

The card can be used by any cardholder anywhere in the World, for example, grandparents, aunts and uncles, students away at college for schoolbooks and supplies, food, allowances, etc. where ATM/Debit Cards are accepted, thus eliminating the geographical restrictions of other fund raising concepts. The more the school ATM/debit card is used, the more money that is generated for a school district. The card management organization website and automated phone access system can be used by the cardholder to manage the card funds, such as track spending, check on the card balance, transfer money to other cards, and load additional funds on to the card.

It is estimated that 20% of the US population, while earning $500 billion, does not have a banking relationship. As such, these individuals are paying fees of 3% to 8% (average 5%) just to cash their paychecks. A $10 an hour employee, working full time and earning about $20,000 per year, may spending over $1,000 annually ($87 monthly) to cash a weekly paycheck. In the absence of a checking account, additional monthly expense to operate a normal household requires up to about 22 money orders per month to pay bills, adding another $16 to monthly expenses. Sending money overseas, typically to family members in the individual's home country, adds expenses averaging $50 to $60 per transaction.

A debit card system as described allows the user to save $1,500 to several thousand dollars annually while at the same time providing a charitable contribution to the non-profit organization sponsoring the card. As a result the card users who do not have a banking relationship can significantly reduce or eliminate the annual costs set forth above, while receiving a tax deduction for the contribution deducted from the transaction fees.

However, the economic benefits of the debit card system described above are not limited to those without a banking relationship. Use of the system also provides cost savings to those currently using a checking account or credit cards. The average cost of a checking account is $218 a year plus another $20 to have the checks printed. At $238 a year the average checking account costs $20 per month. Even “basic” or “no frills” checking accounts impose a variety of fees. Even so called “free” checking accounts apply charges, restrictions or limitations on availability of funds which can be costly to the user. The average American has 12 credit cards with interest rates as high as 19%, annual membership fees and a balance due of $8,500 on average. At a monthly minimum payment of $212.50 it would take 396 months (33 years) to pay off the balance and cost $36 per month ($14,228.50) in interest plus another $5 per month in annual card member fees for a total of $41 per month. A debit card incorporating features of the system, even with a $10 to $15 per month transaction fee, with a minimum of 50% going, to the non-profit as a tax deductible expense, is significantly cheaper, by up to about 75%, to utilize.

Besides reducing costs and providing tax deductible contributions, the debit card system provides added control of finances. Using the card instead of making cash purchases helps to establish a money management system for the individual The ability to see where money is spent is invaluable. When one pays with cash that ability is compromised. Everyone's budget has what personal financial planners refer to as “air-money,” which is all the cash spent during the year on miscellaneous items. When payments are made with a debit card, the purchases appear on the account transaction statement allowing better control of funds which, in turn helps the user to manage spending.

On an annual basis, a sponsor organization, in this instance a school or school district having 1000 user/participants, with each participant using the card for 100 transactions annually and with the portion of the transaction fee transferred to the sponsor organization being $1.00 per transaction, receives $100,000, all with no effort, other than signing up users, by the sponsor and the tax deductible cost to each user is $100/year.

Typical steps in an embodiment of the method of isolating monies (the “PROGRAM”) for a charity (an organization qualifying under IRS 501c(3) (or equivalent foreign regulations) from a debit card or stored value card (“CARD”) utilizing a FDIC insured financial institution (“BANK”), PROGRAM processor (card management organization), and existing ATM and Point-of-sale (POS) computer networks (“NETWORKS”), consisting of the following steps:

Step 1. Charity establishes a donation PROGRAM utilizing the CARD, PROGRAM processor, and BANK.

Step 2. The User (DONOR) receives the CARD from the BANK supporting, participating or cooperating with the Charity's PROGRAM.

Step 3. The DONOR loads personal funds/monies to CARD. Funds/monies are held in trust at BANK for the benefit of Donor/cardholder, and may establish a program, such as direct deposit, for future finding of the CARD.

Step 4. Donor then uses the CARD to withdraw cash from ATMs worldwide or to make purchases for goods and services (“TRANSACTION”) at merchants worldwide that participate on NETWORKS which accept the CARD.

Step 5. Donor is assessed a transaction fee (“FEE”) for each TRANSACTION that is performed with the CARD. TRANSACTION may include deposits, withdrawals, purchases, balance inquiries, declined transactions, funds transfers, phone inquiries/support, monthly/annual maintenance charges, and/or other charges required to administer the PROGRAM.

Step 6. The FEE and the value of the TRANSACTION are instantly debited from the Donor's funds held at the BANK for settlement at the time of the TRANSACTION by the PROGRAM processor through the NETWORKS.

Step 7. ATM provider or merchant is credited with the value of the TRANSACTION by the PROGRAM processor through the NETWORKS from the Donor's funds held at the BANK.

Step 8. The FEE is divided and credited to specific accounts on a pre-determined PROGRAM schedule to:
(a) The Charity;
(b) The BANK for use of the NETWORKS and for maintaining the Donor's debit account;
(c) To the PROGRAM processor for TRANSACTION settlement and administration/operation of the PROGRAM.

Step 9. PROGRAM processor provides in real-time, to both the Donor and Charity, an accounting of the total value of year-to-date contributions generated by the PROGRAM. Donor/cardholder may receive a tax deduction from the Charity on the portion of the FEE that is rebated to the Charity as a charitable donation.

The amount of the TRANSACTION FEE may be established by using several different approaches. In each instance, it will have two parts, a minimum designated amount to cover the cost of operating the system (the “Operating Fee”) and an additional amount designated for transfer to the charity (referred to as the “Additional Fee”). The Transaction Fee can be a fixed sum per transaction established by the BANK or Charity so that every transaction by a user, as well as every transactions by all other users, is the same. For example, a total Transaction fee of $1.00 (or any other appropriate amount) per transaction for each and every transaction may be charged. This simplifies the accounting by the bank and/or the card management organization. One disadvantage to the card user of a fixed fee per transaction is that for small transactions (for example, $5.00 or less) a very large percentage is added to the transaction amount to cover the Transaction Fee. Alternatively, a Transaction Fee which is a fixed percentage of the transaction may be assessed. However, in this situation the portion of the Additional Fee that goes to the charity may vary as the Operating fee must first be deducted, and in some instances, the transaction fee may not be adequate to cover the operating fee. Another alternative would be to hold the Operating fee fixed and have an Additional Fee dependent on the size of the transaction. The Additional Fee may also be fixed for all transactions over a certain dollar amount. A further alternative would have the user specifying, when the account is set up, a fixed dollar amount or variable (i.e. percent of the Transaction) additional amount. Still further, because the user will have electronic access to the account record, the account record could provide various alternatives for the Transaction Fee and provide the user the opportunity to periodically change those choices.

Typical rights and responsibilities of the charitable organization, the managing organization, the account manager and the Bank(s) are as follows

Responsibilities of Charitable Organization

1) Maintain a deposit account at the bank, typically non-interest bearing (“ORG Account”).

2) Enter into a contractual relationship with the managing organization.

3) Provide Members with applications to apply for the card. Cards are sent directly to the cardholder.

4) Establish a program to promote the Card and its use.

5) Establish procedures for working with the managing organization to resolve customer service issues, especially lost or stolen cards.

Responsibilities of the Managing Organization(s)

1) Operate, support and administer the ATM/Debit Card Service (the “Service”) to facilitate the transfer of funds electronically between user and various entities displaying the matching network logos displayed on card, such as VISA, MasterCard, STAR, Cirrus, Interlink, etc.

2) Handle all products, services, and pricing.

3) Prepare and furnish promotional literature, current price lists, etc.

4) Coordinating marketing and sales support of the Program to ORG.

5) Provide, on a monthly basis, reports of sales and transaction fees earned by the charitable organization.

6) Provide operational support, administration and customer service for all of Programs for each charitable organization participating in the Debit Card System

7) Provide the Cardholder with individual card information, and other transaction services through an Interactive Telephone Service and secure website.

Responsibilities of Bank(s)

1) The Bank(s) are preferably full service, Federally charted, card network issuing members, and FDIC insured commercial banks offering customers a range of products that includes a stored value cash card product that provides cardholders access to cash through either specified merchant outlets or ATM machines and point of sale (“POS”) facilities throughout the world utilizing its membership in VISA, MasterCard, STAR, Cirrus, Interlink or other funds transfer networks, collectively (the “Network”). However, they may alternatively be financial institutions with the same capabilities, such as credit unions, brokerage houses, savings and loan institutions, etc. that can provide cards to clients.

2) Issue cards to cardholders following card network rules and regulations at a specified fee schedule per transaction.

3) For each activate account with automatic transfer of the Additional Fee to the ORG Account and the Management Fee to the management account.

4) Provide each Cardholder full access to the funds assigned to the Card in the possession of the Cardholder.

The Bank and the Management Organization may separately handle or share responsibilities regarding transferring of fees, providing reports, and performing other finds transfer and accounting activities

While the description above is based on a specific charitable organization establishing a relationship with a card holder through a card issuing Bank through a funds transfer system managed by a designated card management organization, one skilled in the art will recognize that variations thereof are within the scope of the system described herein. For example, it is not necessary that the relationship be between the card holder and a single charitable organization. That charitable organization could be a group of charitable entities or an organization that distributes funds to different organizations, such as the United Fund, a consortium of charitable hospitals, or a school district having multiple facilities, or any combination thereof. The Additional fee would then go to the specified organizations and could further be designated to be distributed to one or more of the entities within the group or specific functions, such as all art activities in a school district or specified schools in that district (i.e. the high school or a specified grammar school). Still further, the system could be set up as a relationship between the cardholder, bank and management organization to segregate the additional funds and periodically distribute those funds to one or more selected charities not part of the above described system (i.e., to distribute the funds, on a quarterly basis to a designated organization such as the Salvation Army, a Boy Scout troop, etc).

It is also contemplated that the Management Organization, instead of the Charity, may have the account with the Bank. In such an instances the designated portion of the transaction fee is transferred to the Management Organizations account. The Management Organization then assumes the obligation to distribute finds to the designated charities after subtracting its management fees.

Still further, while the system has certain advantages as a mechanism to provide charitable donations, it can also be used by the card holder as a forced savings plan. In such an instance rather then the funds being transferred to an account for a participating charitable organization, the additional fees can be transferred to a separate account set up by the cardholder, such as a education savings account or a medical savings account, which may comply with special statutory or regulatory requirements to provide to the cardholder certain tax advantages.

1. A funds transfer system comprising a funded account and a means for withdrawal from and loading of funds to that funded account, said means specific to and usable only by a designated accountholder, wherein the use thereof by an accountholder in a financial transaction:
a) causes funds to be transferred from the funded account of the accountholder to a receiving party designated in that financial transaction by the accountholder
b) reduces the funded account by the amount of the financial transaction, and
c) causes a specified transaction fee to be deducted from the funded account, the transaction fee comprising one or more of a maintenance fee and additional fees, said additional fee or fees credited to one or more designated separate accounts.

2. The funds transfer system of claim 1 wherein the means for withdrawal is a debit, stored value, prepaid stored value or gift card, or a card or account that has a cash value but does not extend credit to the accountholder or an electronic transfer access device and the accountholder must enter a PIN number or system recognizable signature to cause the funds to transfer.

3. The funds transfer system of claim 1 wherein the additional fee is a fixed dollar amount or a percentage of the dollar value of the transaction.

4. The funds transfer system of claim 1 wherein the designated separate account is an account of an organization which qualifies for tax purposes as a charitable or non-profit organization.

5. The funds transfer system of claim 1 wherein the transfer of the additional fee to a separate account generates a potential tax deduction for the accountholder.

6. The funds transfer system of claim 1 wherein the designated separate account is an account of an entity which receives the additional funds for later transfer to an organization which qualifies for tax purposes as a charitable or non-profit organization.

7. The funds transfer system of claim 1 wherein the account holder also has electronic access to the account to manage the accountholder's funds in the account.

8. The funds transfer system of claim 7 wherein managing the account includes the ability for the accountholder to direct one or more of
a) electronically transferring funds into and out of the account,
b) changing the amount or manner of calculating the additional fee,
c) changing the designated entity receiving the additional finds, and
d) changing the directed manner in which the designated entity can use the finds.

9. A funds transfer system comprising an account pre-funded by an accountholder, said accountholder having an access card for accessing, withdrawing, loading, and transferring funds in said account to a third party wherein performing a transaction using the card causes a designated amount of funds to be transferred to said third party and a specified transaction fee to be withdrawn from said account and credited to the accounts of pre-designated entities, said transaction fee comprising at least a maintenance fee transferred to a first designated entity and an additional fee transferred to an account for a second designated entity.

10. The funds transfer system claim 9 wherein the access card is a debit, stored value, prepaid stored value or gift card, or a card or account that has a cash value but does not extend credit to the accountholder, or an electronic transfer access device.

11. The funds transfer system claim 9 wherein the accountholder also has electronic access to the account so the accountholder can manage the finds in the account.

12. The funds transfer system of claim 11 wherein managing the account includes the ability for the accountholder to direct one or more of
a) electronically transferring funds into or out of the account,
b) changing the amount or manner of calculating the additional fee,
c) changing the designated entity receiving the additional finds, and
d) changing the directed manner in which the designated entity can use the funds.

13. The finds transfer system of claim 9 wherein the accountholder must enter a PIN number or signature to activate the funds transfer system.

14. The funds transfer system of claim 9 wherein the additional fee is a fixed dollar amount or a percentage of the dollar value of the transaction.

15. The funds transfer system claim 9 wherein the second designated entity is an organization which qualifies for tax purposes as a charitable or non-profit organization.

16. The finds transfer system claim 9 wherein the transfer of the additional fee to a separate account generates a potential tax deduction for the accountholder.

17. The funds transfer system claim 9 wherein the designated separate account is an account of an entity which receives the additional funds for later transfer to an organization which qualifies for tax purposes as a charitable or non-profit organization.
